(19) United States
(12) Patent Application Publication
(10) Pub. No.: US 2012/0307008 A1
(43) Pub. Date: Dec. 6, 2012

(54) PORTABLE ELECTRONIC DEVICE WITH RECORDING FUNCTION

(75) Inventors: Kuan-Wei LEE, New Taipei City (TW); Wei-Cheng Huang, New Taipei City (TW); Mei-Yi Tsai, New Taipei City (TW)

(73) Assignee: Chicony Electronics Co., Ltd.

(21) Appl. No.: 13/153,547

(22) Filed: Jun. 6, 2011

(51) Int. Cl. H04N 13/02

(52) U.S. Cl. 348/46

(57) ABSTRACT

A portable electronic device with recording function includes a main body, a hinge member, a covering body, a first image capturing module and a second image capturing module. One side of the hinge member is connected to the main body and another side is connected to the covering body so that the covering body has at least a rotary axial direction of movement. The first image capturing module is disposed on the main body and includes a zoom lens and a first image-sensing element. The second image capturing module is disposed on the covering body and includes a stereoscopic image recoding unit and at least a second image sensing element.

### BACKGROUND OF THE INVENTION

1. Field of the Invention

The present invention relates to image recording device, and in particular to an electronic device with 2D image and 3D image recording function.

2. Description of Prior Art

Since the first camera had invented in 1850, photography technique has experienced a breakthrough from black and white to color, and Color photography has been widely popular in the world. The next target is stereoscopic photography and stereoscopic pictures. 3D photography is a dream that mankind seeks for several years and it completely breaks the limitations of the planar photography and shows the real 3D world.

Due to the human eyes parallax, a stereoscopic image is imaged on the retinas by object light. Because the eyes of each human are apart from a certain distance, the images which are formed in eyes are the same in substance but slightly different by the parallax and then a stereoscopic image is synthesized by brain. This parallax feature of eyes is used for achieving stereoscopic recording device.

In order to present the stereoscopic images, a double lenses recording device is disclosed. Reference is made to FIG. 1, which is a perspective view of a conventional portable electronic device with stereoscopic image lens. The portable electronic device with stereoscopic image lens 50 includes a main body 52 and a covering body 54. The covering body 54 is connected to the main body 52 via a hinge member. Two lenses 53 are disposed on the main body 52. A displaying unit 55 is disposed on the covering body 54 for displaying the images recorded by the lenses 53. The hinge member makes the coving body 54 have at least a rotary axial direction of movement relative to the main body 52.

Because the imaging quality of the portable electronic device with stereoscopic image lens is decided by the distance of the lenses, a predetermine distance located between the lenses can effective improve the imaging quality. However, the predetermined distance cause that the main body cannot effectively reduce.

In order to reduce the volume of the portable electronic device with stereoscopic lenses, gun-type stereoscopic recording device is becoming a key of development and research. Compared to the device mentioned above, gun-type stereoscopic recording device has advantages of smaller volume and convenient carry. However, the predetermined distance of the lenses is limited by the small volume so that the stereoscopic recording device is just suitable for short range recoding, long range recording image cannot be effectively viewed.

Besides, for convenient using, a combined device is disclosure for recording planar (2D) images and stereoscopic (3D) images. However, lenses for recording the 2D images and 3D images are all disposed on the main body of the device. For example, the lenses for recording the 2D images and 3D images are disposed on the same side or different sides of the main body so that the volume of main body cannot effectively be reduced.

Under the condition of without volume increment of the main body, the 2D images and 3D images have to share lenses. In more particularly, the 2D image recoding uses one of the lens and the 3D image recording uses both lenses at the same time. However, the 2D image is limited to the specifications of the 3D image recording, and cannot achieve high quality imaging result.

What is needed, therefore, is to provide an electronic device with planar images and stereoscopic images recording function in a limited volume, and has high quality of the planar images.

### SUMMARY OF THE INVENTION

Accordingly, the present invention provides a portable electronic device can record planar images and stereoscopic images.

Therefore, the present invention provides a portable electronic device with recording function. The portable electronic device with recording function includes a main body, a hinge member, a covering body, a first image capturing module and a second image capturing module. One side of the hinge member is connected to the main body and another side is connected to the covering body so that the covering body has at least a rotary axial direction of movement. The first image capturing module is disposed on the main body and includes a zoom lens and a first image-sensing element. The second image capturing module is disposed on the covering body and includes a stereoscopic image recoding unit and at least a second image sensing element.

The portable electronic device with recording function provides not only the first image capturing module for recoding planar images (2D image) but the second image capturing module for recoding stereoscopic images (3D image), and the zoom lens of first image capturing module can provides high quality planar image recoding, and the second image capturing module is disposed on the covering body of the portable electronic device with recording function can effectively reducing the volume of the main body so that the device can become thinner and has an advantage of convenient carrying.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of a conventional portable electronic device with stereoscopic image lens.

FIG. 2 is a perspective view of a portable electronic device with recording function according to a first embodiment of the present invention;

FIG. 3 is a circuit block diagram of the portable electronic device with recording function according to the first embodiment;

FIG. 4 is a perspective view of the portable electronic device with recording function according to a second embodiment;

FIG. 5 is a perspective view of the portable electronic device with recording function according to a third embodiment;

FIG. 6 is a perspective view of the portable electronic device with recording function according to a fourth embodiment.

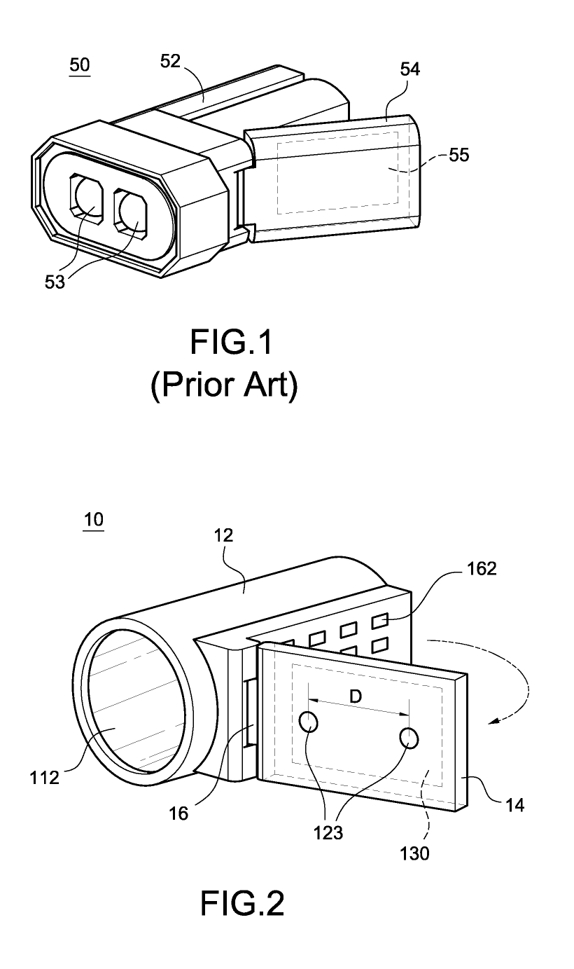

### DETAILED DESCRIPTION OF THE INVENTION

A preferred embodiment of the present invention will be described with reference to the drawings.

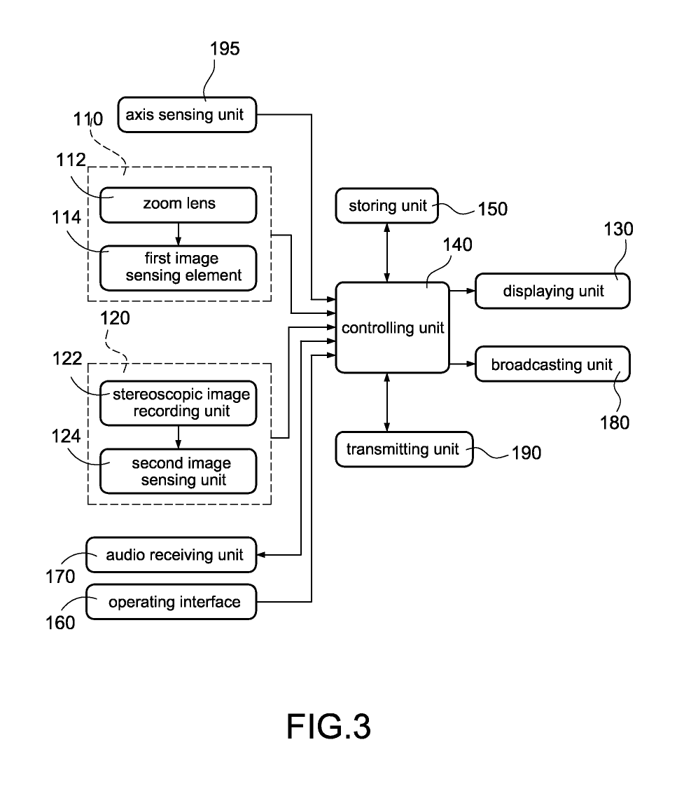

Reference is made to FIG. 2 and FIG. 3, which are a perspective view and a circuit block diagram of a portable electronic device with recording function. The portable electronic device with recording function may be a digital video camcorder, a mobile phone or a digital camera.

In this embodiment, the portable electronic device with recording function 10 is a hand-held transverse digital camcorder. The portable electronic device with recording function 10 includes a main body 12, a cover body 14 and a hinge member 16. The main body 12 and the covering body 14 are connected to both side of the hinge member 16, respectively, so that the covering body 14 has a rotary axial direction of movement relative to the main body 12. Moreover, the covering body 14 can be rotated away from and have an included angle with the main body 12 or can be rotated to cover the main body 12.

A first image capturing module 110 is disposed on the main body 12 and includes a zoom lens 112 and a first image sensing element 114. The zoom lens 112 is connected to the first image sensing element 114. The zoom lens 112 is used for recording a planar image (2D image) of an object, the first image sensing element 114 converts the planar image into a first digital image signal. The first image sensing element 114 may be a charge coupled device (CCD), complementary metal-oxide semiconductor (CMOS) or other elements have characteristic of photoelectric conversion.

A second image capturing module 120 and a displaying unit 130 are disposed on the covering body 14. The second image capturing module 120 includes a stereoscopic image recording unit 122 and at least a second image sensing unit 124. The stereoscopic image recoding unit 122 includes two prime lenses 123. The adjacent prime lenses 123 have a disposing distance D, the disposing distance D is located between 2 to 7 centimeters. Moreover, each of the prime lenses 123 has a tilt angle of 0 to 5 degrees, more particularly, the tilt angle are 2 to 5 degrees. In this embodiment, the two prime lenses 123 are respectively connected to two second image sensing elements 124, namely, the second image capturing module 120 includes two second image sensing elements 120 for enhancing the image quality of the stereoscopic image. The two prime lenses 123 are used for recording a stereoscopic image (3D image) of an object. The second image sensing elements 124 convert the stereoscopic image recorded by the prime lenses into a second digital image signal, respectively. The second image sensing element 124 may be a charge coupled device, complementary metal-oxide semiconductor or other elements have characteristic of photoelectric conversion.

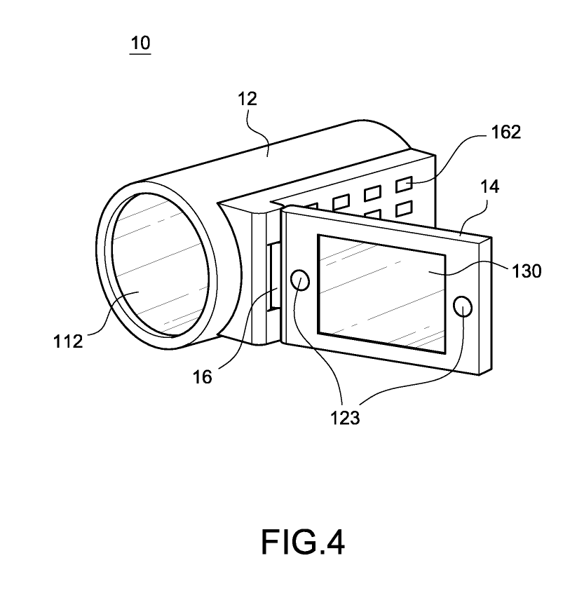

The displaying unit 130 is used for displaying the images recorded by the first image capturing module 110 and the second image capturing module 120. In this embodiment, the displaying unit 130 is a touch screen. Moreover, the displaying unit 130 and the second image capturing module 120 can be disposed on opposite sides of the covering body or the displaying unit 130 and the second image capture module 120 can be disposed on the same side of the covering body 14 (shown in FIG. 4).

Referring to the FIG. 3 again, the portable electronic device with recording function 10 further includes a controlling unit 140, a storing unit 150, an operating interface 160, an audio receiving unit 170, a speaker 180 and a transmitting unit 190.

The controlling unit 140 is disposed on the main body 12 and electrically connected to the first image capturing module 110 and the second image capturing module 120 to receive the first digital image signal transmitted from the first image sensing element 114 and the second digital image signals transmitted from the second image sensing elements 124.

The storing unit 150 is disposed on the main body 12 and electrically connected to the controlling unit 140. The storing unit 150 may be an internal memory or a removable memory card for storing the first digital image signal and the second digital image signals.

The operating interface 160 can be, for example, the controlling icons displayed on the displaying unit 130 with touch function mentioned above so that user can set operating commands of the portable electronic device with recording function 10 by touching the controlling icons Moreover, the operating interface 160 may be multiple keys 162 for another example. The keys 162 are disposed on the main body 12 or the covering body 14 and electrically connected to the controlling unit 140. Users can set operating commands of the portable electronic device with recording function 10 by pressing the keys. Besides, the operating interface 145 can simultaneously include the controlling icons displayed on the displaying unit 130 and the keys for convenient operating.

The audio receiving unit 170 is electrically connected to the controlling unit 140 for receiving an external voice and converting the external voice into an audio signal, wherein the audio receiving unit 170 is, for example, a microphone. The audio signal is transmitted to the controlling unit 140 and the controlling unit 140 decides that the audio signal is stored to the storing unit 150 or broadcast outward by the speaker 180. The speaker 180 is electrically connected to the controlling unit 140.

The transmitting unit 170 is electrically connected to the controlling unit 140. The transmitting unit 170 may be data transmitting ports, audio transmitting outputting terminal or image outputting terminal used for connecting to an external thumb device, hard disc or electronic device and transmitting audio data or video data. Moreover, the transmitting unit 165 may be a WIFI transmitting interface, Bluetooth interface or other wireless interface to provide wireless transmission of the video data and audio data.

The portable electronic device 10 further includes an axis sensing unit 195. The axis sensing unit 195 is electrically connected to the controlling unit 140 for sensing a rotary angle between the main body 12 and the covering body 14 and sends the sensing result to the controlling unit 140. When the rotary angle between the main body 12 and the covering body 14 equals zero and users want to turn on the second image capturing module 120 and record stereoscopic images, the controlling unit 140 displays a notice that the covering body 14 with the second image capturing module 120 has to rotate to face the objects.

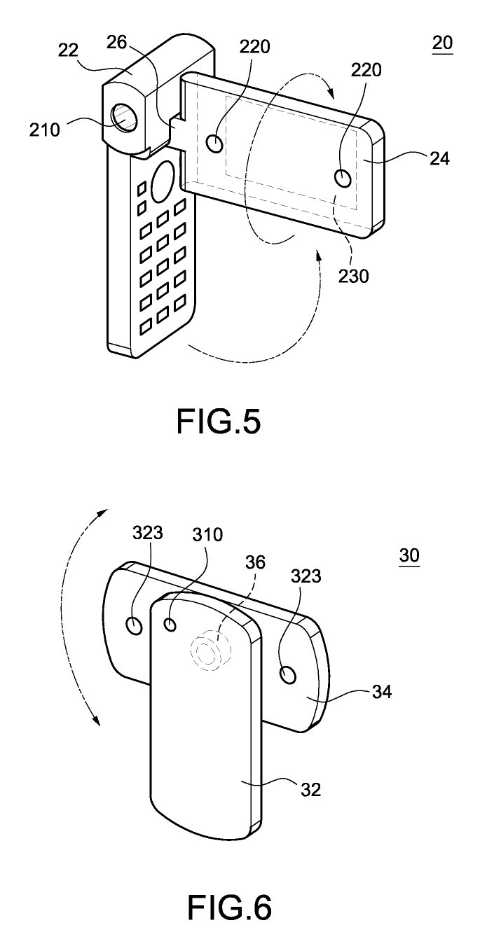

Reference is made to FIG. 5, which is a perspective view of a portable electronic device with recording function according to the third embodiment of the present invention. In is embodiment, the portable electronic device with recording function 20 is similar to the first embodiment mentioned above. The difference is that the portable electronic device with recording function 20 in this embodiment is a hand-held erective type digital camcorder. The portable electronic device with recording function 20 is thinner and smaller than the first embodiment mentioned above so that user can easily and conveniently carry it. A covering body 24 of the portable electronic device with recording function 20 is connected to a main body 22 via a hinge member 26. A first image capturing module 210 is disposed on the main body 22. A second image capturing module 220 and a displaying unit 230 are disposed on the covering unit 21, wherein the second image capturing module 220 and the displaying unit 230 may be disposed on the same side of the covering body 22, or disposed on the different sides of the covering body 22. The hinge member 26 makes the covering body 24 has two rotary axial directions of movement relative to the main body 22. In one rotary axial direction, the covering body 24 can raise an angle toward a direction which is opposite to the main body 22 or close to the main body 22. In another rotary axial direction, one side of the covering body 24 which has the displaying unit 230 can shift the relative position related to the first image capturing module 210.

Reference is made to FIG. 6, which is a perspective view of a portable electronic device with recording function according to the fourth embodiment of the present invention. In this embodiment, the portable electronic device with recording function 30 is a cap-type mobile phone and similar to the first embodiment mentioned above. The difference is that a covering body 34 of the portable electronic device with recording function 30 is superposed on a main body 32 via a hinge member 36. A first image capturing module 310 is disposed on the main body 32. A second image capturing module having two prime lenses 323 and a displaying unit (not shown) are disposed on the covering body 34. In this embodiment, the second image capturing unit and the displaying unit are disposed on different sides of the covering body 34. Because the hinge member 36 the covering body 34 has a rotary axial direction of movement relative to the main body 22, in this embodiment, the hinge member allows the covering body 34 can be rotated relative to the main body 32.

Users have to rotate the covering body 34 relative to the main body 32 so that the prime lenses 323 is exposed to the main body 32 and faces the object when users want to record a stereoscopic image. In other cases without the need of recoding stereoscopic image, the covering body 34 is rotated to the position that is superposed to the main body 32 so that the prime lenses 323 is hided between the main body 32 and the covering body 34 and this has advantage of anti-dirt. Besides, the prime lenses 323 can be disposed on the side of the covering body 34 which had the displaying unit 330 for capturing self-image of user and achieving the function of video phone call.

In conclusion, the portable electronic device with recording function provides not only the first image capturing module for recoding planar images but the second image capturing module for recoding stereoscopic images, and the zoom lens of first image capturing module can provides high quality image recoding, and the second image capturing module is disposed on the covering body of the portable electronic device with recording function so that can effectively reducing the volume of the main body so that the device can become thinner and has an advantage of convenient carrying.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A portable electronic device with recording function, comprising:
a main body;
a hinge member, one side of the hinge member connected to the main body;
a covering body connected to another side of the hinge member so that the covering body has at least a rotary axial direction of movement;
a first image capturing module disposed on the main body and comprising a zoom lens and a first image sensing element; and
a second image capturing module disposed on the covering body and comprising a stereoscopic image recoding unit and a second image sensing element.

2. The portable electronic device with recording function in claim 1, wherein the stereoscopic image recoding unit comprising two prime lenses and a disposing distance of the prime lenses is of 2 to 7 centimeters.

3. The portable electronic device with recording function in claim 2, wherein each prime lens has a tilted angle, the tilted angle is of 0 to 5 degrees.

4. The portable electronic device with recording function in claim 3, wherein the tilted degree is of 2 to 5 degrees.

5. The portable electronic device with recording function in claim 1, further comprising a displaying unit disposed on the covering body and on the same side where the two prime lenses disposed.

6. The portable electronic device with recording function in claim 1, further comprising a displaying unit disposed on the covering body and on an opposite side where the prime lenses disposed.

7. The portable electronic device with recording function in claim 1, further comprising:
a controlling unit disposed on the main body and electrically connected to the first image capturing module and the second image capturing module and receiving a first digital signal transmitted from the first image sensing element and a second digital signal transmitted from the second image sensing element;
a storing unit electrically connected to the controlling unit and used to store the first digital image signal and the second digital image signal; and
an operating interface electrically connected to the controlling unit for operating and controlling the portable electronic device with recording function.

8. The portable electronic device with recording function in claim 7, wherein the storage unit is an internal memory or a removable memory card.

9. The portable electronic device with recording function in claim 7, wherein the operating interface is controlling icons disposed on touch screen or keys disposed on the main body or covering body.

10. The portable electronic device with recording function in claim 7, further comprising:
an audio receiving unit electrically connected to the controlling unit for capturing an external voice and converting the external voice to a audio signal, the audio signal stored to the storing unit via the controlling unit; and
a speaker electrically connected to the controlling unit for converting the audio signal to a voice and broadcasting to outward.

11. The portable electronic device with recording function in claim 7, further comprising a transmitting unit electrically connected to the controlling unit for connecting to a external device and transmitting data.

12. The portable electronic device with recording function in claim 11, wherein the transmitting unit us a digital-date transmitting port, audio outputting terminal or image outputting terminal.

13. The portable electronic device with recording function in claim 11, wherein the transmitting unit is a WIFI transmission interface or a Bluetooth transmission interface.

14. The portable electronic device with recording function in claim 7, further comprising an axis sensing unit electrically connected to the controlling unit for sensing the rotary angle between the covering body and the main body.
